(19) United States
(12) Patent Application Publication
(10) Pub. No.: US 2010/0062895 A1
(43) Pub. Date: Mar. 11, 2010

(54) REDUCTION MECHANISM

(75) Inventor: Stefan Frits Brouwer, Schoonhoven (NL)

Correspondence Address: DYKEMA GOSSETT PLLC, 39577 WOODWARD AVENUE, SUITE 300, BLOOMFIELD HILLS, MI, 48304-5086, US

(73) Assignee: MCi (Mirror Controls International) Netherlands B.V., Montfoort (NL)

(21) Appl. No.: 12/520,695

(22) PCT Filed: Dec. 21, 2007
(86) PCT No.: PCT/NL2007/050697

§ 371 Date: Nov. 10, 2009

(30) Foreign Application Priority Data
Dec. 22, 2006 (NL) 1033127

(51) Int. Cl. F16H 57/08; F16H 1/22

(52) U.S. Cl. 475/331

(57) ABSTRACT

A reduction mechanism including an input gear wheel, an output gear wheel, and at least one intermediate gear wheel is disclosed. The input gear wheel is provided with outer toothing, which may be configured for coupling with a driving motor, and includes an evoloid toothing having one or two teeth. An output gear wheel is provided with an evoloid inner toothing. In an embodiment, the output gear speed during use is lower than the speed of the input gear wheel. The at least one intermediate gear wheel is operative between the input gear wheel and the output gear wheel and the rotation axis of the at least one intermediate gear wheel is fixedly arranged. In an embodiment, the reduction mechanism may be configured so that the input gear wheel, the output gear wheel, and the at least one intermediate gear wheel are situated substantially in a single plane.

This invention relates to a reduction mechanism.

Reduction mechanisms are generally known and are used to convert the speed of a motor, for instance an electric motor, to a lower speed.

A known reduction mechanism is a planetary gear transmission. A planetary gear transmission usually comprises an input gear wheel provided with an outer toothing, which cooperates with at least one planetary gear wheel. The rotation axis of a planetary gear wheel moves around the input gear wheel and is not fixedly arranged. The planetary gear wheels cooperate with a ring-shaped output gear wheel.

When in particular applications a high transmission ratio is desirable, use is made, for instance, of a reduction mechanism of the ‘harmonic drive’ principle.

A harmonic drive reduction mechanism comprises an outer toothed ring, provided with an inner toothing, in which outer toothed ring an inner toothed ring provided with an outer toothing is operative, this inner ring being flexible but connected with the fixed world so as to be restrained from rotation. The inner toothed ring has two teeth less than the outer toothed ring, and is pressed against the outer toothed ring by two press-on bodies. The two press-on bodies are rotatably arranged symmetrically with respect to an input situated on an input shaft. The input is situated eccentrically with respect to the outer toothed ring. As a consequence, at two respective points, the inner toothed ring has a number of teeth cooperating with teeth of the outer toothed ring. When the two press-on bodies are going to rotate about the common shaft of inner and outer ring, then, owing to the inner toothed ring being connected with the fixed world so as to be restrained from rotation, the outer toothed ring will start to rotate. This rotation amounts, per revolution of the press-on bodies, to an angle corresponding to the angle of rotation of two teeth.

Accordingly, a harmonic drive reduction mechanism has a high transmission ratio.

A disadvantage of a harmonic drive reduction mechanism is that the mechanism is relatively complex because it includes many parts. Also, the mechanism has a relatively high overall height and a relatively low efficiency.

An object of the invention is to provide an alternative reduction mechanism, whereby the disadvantages mentioned can be obviated whilst maintaining the advantages.

To this end, the invention provides a reduction mechanism comprising

an input gear wheel provided with an outer toothing, for coupling with a driving motor, which input gear wheel is provided with an evoloid toothing with only 1 or 2 teeth;

an output gear wheel provided with an inner toothing;

at least one intermediate gear wheel which is operative between the input gear wheel and the output gear wheel and whose rotation axis is fixedly arranged.

An evoloid toothing of the input gear wheel is understood in this context to mean a pinion having a toothing according to DIN 3960, whereby

the number of teeth Z is equal to 1 or 2;

the tooth angle β is greater than 15°;

the profile correction x1 of the pinion is greater than 0.5;

the profile correction x2 of the intermediate gear wheel is less than or equal to 0;

the tooth root height factor h_{FfP2} of the intermediate gear wheel is greater than or equal to the tooth head height factor h_{aP1} of the pinion; and

the tooth head height factor h_{aP2} of the intermediate wheel is substantially equal to the tooth root height factor h_{Ffp1} of the pinion. The intermediate gear wheel and the output gear wheel have a corresponding toothing.

Such an evoloid toothing is a special variant of the involute toothing and is discussed in more detail by K. Roth in Zahnrad Technik—Evolventen Sonderverzahnungen, Springer Verlag ISBN 3-540-64236-6.

By virtue of the use of an input gear wheel with an evoloid toothing cooperating via an intermediate gear wheel with the output gear wheel, in a simple manner an input gear wheel with a small tooth number can be used in the reduction mechanism. This results in a simple and compact construction.

By using two or more intermediate gear wheels, operational reliability can be enhanced, and the construction can remain simple. By virtue of the use of two or more intermediate gear wheels, in particular, the force transmitted by the reduction mechanism can be large, since an input force is divided between the two intermediate gear wheels.

By making use of an output gear wheel provided with an inner toothing, the intermediate gear wheels and input gear wheel can be enclosed by the output gear wheel in a compact and elegant manner. This renders the reduction mechanism robust and less vulnerable.

In an advantageous embodiment, the gear wheels are situated substantially in one plane. As a result, a low overall height is obtained, which renders the construction of the reduction mechanism more compact.

In another advantageous embodiment, the input shaft of the reduction mechanism is situated directly on an output shaft of a driving motor. As a consequence, fewer parts can be used, so that the overall construction of the reduction mechanism can be rendered still more compact.

The invention will be further elucidated on the basis of an exemplary embodiment which is represented in a drawing. In the drawing:

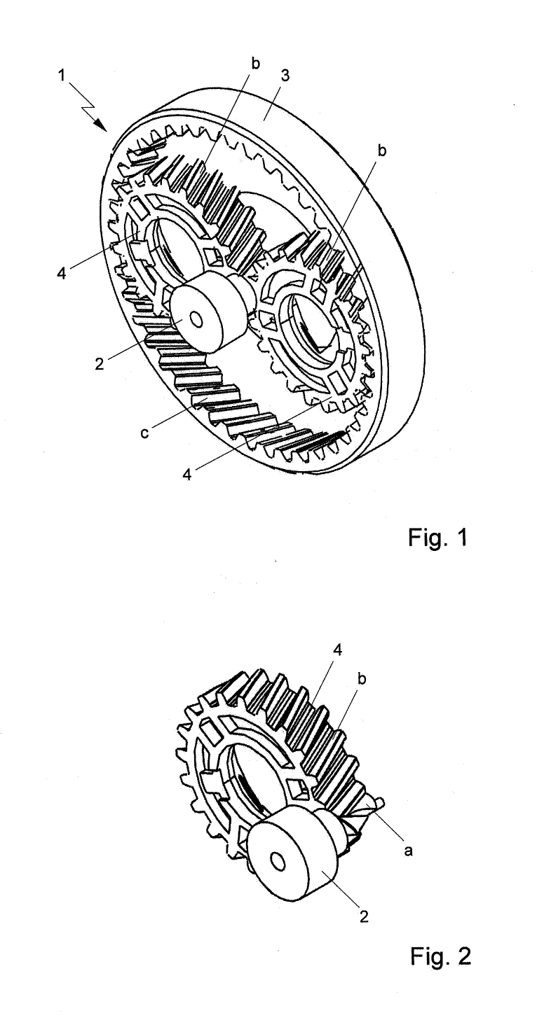

FIG. 1 shows a schematic perspective view of a reduction mechanism according to the invention;

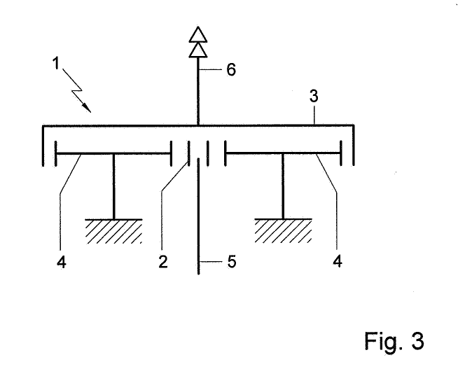

FIG. 2 shows a detail of the reduction mechanism of FIG. 1;

FIG. 3 shows a schematic of the reduction mechanism of FIG. 1.

It is noted that the figures are only schematic representations of a preferred embodiment of the invention, which is described by way of non-limiting exemplary embodiment. In the figures, the same or corresponding parts are designated with the same reference numerals.

A reduction mechanism according to the invention is shown in FIG. 1. The reduction mechanism 1 comprises an input gear wheel 2 provided with an evoloid outer toothing a. The input gear wheel 2 is provided with an evoloid outer toothing b, as shown in FIG. 2. In the exemplary embodiment of FIG. 2, the input gear wheel 2 is designed with two teeth.

Further, the reduction mechanism 1 comprises an output gear wheel 3 provided with an evoloid inner toothing c. During use, the speed of the output gear wheel 3 is lower than the speed of the input gear wheel 2. The speed is reduced in accordance with the transmission ratio of the reduction mechanism.

Furthermore, the reduction mechanism 1 in the exemplary embodiment of FIG. 1 comprises two intermediate gear wheels 4 arranged symmetrically with respect to the input gear wheel 2. Each intermediate gear wheel 4 is provided with an outer toothing b and cooperates with both the input gear wheel 2 and the output gear wheel 3.

The input gear wheel 2 is situated in the centre of the output gear wheel 3 designed as a toothed ring, arranged concentrically around the input gear wheel 2. In particular, the centerline of the input gear wheel 2 is coaxial with the centerline of the output gear wheel 3.

The intermediate gear wheels 4 have rotation axes which are fixedly arranged with respect to the fixed world, as schematically represented in FIG. 3. The intermediate gear wheels 4 are driven via the input gear wheel 2 and rotate about their own axis. By the rotation of the intermediate gear wheels 4, the output gear wheel 3 is driven. The speed of the output gear wheel 3 is then lower than the speed of the input gear wheel 2. Preferably, the transmission ratio of the reduction mechanism 1 is at least 1:20. Greater transmission ratios are also possible, for instance a transmission ratio of 1:40 or 1:50 can also be realized.

In the embodiment of FIG. 1, the gear wheels 2, 3 and 4 are situated substantially in one plane. As a consequence, the overall height of the reduction mechanism remains low, so that a simple and compact reduction mechanism has been obtained.

In an advantageous embodiment, the input gear wheel 2 is carried directly on an output shaft 5 of a driving motor not shown here. In this way too, the overall construction of the reduction mechanism remains compact, and little space is needed for the reduction mechanism.

The output gear wheel 3 may be coupled with an output shaft 6 of the reduction mechanism, as shown schematically in FIG. 3.

It will be clear that the invention is not limited to the exemplary embodiments represented here. Many variants will be clear to those skilled in the art and are understood to be within the scope of the invention as set forth in the following claims.

1-5. (canceled)

6. A reduction mechanism comprising:
an input gear wheel provided with an outer toothing, the input gear is configured for coupling with a driving motor and includes an evoloid toothing with one or two teeth;
an output gear wheel provided with an evoloid inner toothing, wherein the output gear speed during use is lower than the speed of the input gear wheel;
at least one intermediate gear wheel operative between the input gear wheel and the output gear wheel, wherein the rotation axis of the intermediate gear wheel is fixedly arranged.

7. The reduction mechanism of claim 6, wherein the reduction mechanism is provided with two intermediate gear wheels.

8. The reduction mechanism of claim 6, wherein the reduction mechanism is provided with a plurality of intermediate gear wheels that each include an outer toothing, and each of the plurality of intermediate gear wheels are configured for operative communication with both the input gear and the output gear.

9. The reduction mechanism of claim 6, wherein the input gear wheel is supported symmetrically by two or more intermediate gear wheels whose rotation axes are fixedly arranged.

10. The reduction mechanism of claim 6, wherein the input gear wheel is situated in the center of the output gear wheel.

11. The reduction mechanism of claim 6, wherein the centerline of the input gear wheel is coaxial with the centerline of the output gear wheel.

12. The reduction mechanism of claim 6, wherein the at least one intermediate gear wheels is configured to be driven by the input gear wheel, and the output gear wheel is configured to be driven by the rotation of the at least one intermediate gear wheel about its own rotation axis.

13. The reduction mechanism of claim 6, wherein the output gear wheel is coupled with an output shaft.

14. The reduction mechanism of claim 6, wherein the input gear wheel, the output gear wheel, and the at least one intermediate gear wheel are situated substantially in one plane.

15. The reduction mechanism of claim 6, wherein the input gear wheel is carried directly on an output shaft of said driving motor.

16. The reduction mechanism of claim 6, wherein the transmission ratio is at least 1:20.

17. The reduction mechanism of claim 6, wherein the transmission ratio is at least 1:40.

18. The reduction mechanism of claim 6, wherein the transmission ratio is at least 1:50.

19. A reduction mechanism comprising:
an input gear wheel provided with an outer toothing, the input gear is configured for coupling with a driving motor and includes an evoloid toothing with one or two teeth;
an output gear wheel provided with an evoloid inner toothing, wherein the output gear speed during use is lower than the speed of the input gear wheel;
a plurality of intermediate gear wheels operative between the input gear wheel and the output gear wheel, wherein each of the plurality of intermediate gear wheels include an outer evoloid outer toothing, each of the plurality of intermediate gear wheels are configured for operative communication with both the input gear and the output gear, and the rotation axis of each of the plurality of intermediate gear wheels is fixedly arranged.

20. The reduction mechanism of claim 19, wherein the input gear wheel, the output gear wheel, and the plurality of intermediate gear wheels are situated substantially in one plane.
